(19) United States
(12) Patent Application Publication
(10) Pub. No.: US 2023/0130181 A1
(43) Pub. Date: Apr. 27, 2023

(54) Pool Massage Raft

(71) Applicant: Jerry Carlyell Weisser, Orlando, FL (US)

(72) Inventor: Jerry Carlyell Weisser, Orlando, FL (US)

(21) Appl. No.: 18/049,557

(22) Filed: Oct. 25, 2022

Related U.S. Application Data
(60) Provisional application No. 63/271,640, filed on Oct. 25, 2021.

(51) Int. Cl. A61H 37/00

(52) U.S. Cl. CPC A61H 37/005

(57) ABSTRACT

A pool raft for receiving a massage. The raft has an outer frame, body support frames, and a headrest. The raft has magnetic connectors in the body supports to allow individual supports to break away according to the comfort of the user. The outer frame includes cupholders.

### FIELD OF THE INVENTION

The present invention relates to pool rafts. More specifically, the present invention relates to floating massage tables.

### BACKGROUND OF THE INVENTION

When it comes to therapeutic massages or of the likes, there are many different methods and equipment used to ease the body and mind. Typically, therapeutic massages require two people, a person getting massaged and a person who is doing the massage. The person receiving the massage lays on a table, and the person giving the massage stands next to the table.

An objective of the present invention is to provide a device used for therapeutic massages. The present invention provides a pool raft used within a body of water such as a pool. The present invention provides a device used for therapeutic massage within a body of water. Furthermore, the present invention provides a pool raft that allow the user to lay down and float on the surface a body of water.

### SUMMARY OF THE INVENTION

The present invention is a pool raft for receiving a massage. The raft has an outer frame, body support frames, and a headrest. The raft has magnetic connectors in the body supports to allow individual supports to break away according to the comfort of the user. The outer frame includes cupholders.

### BRIEF DESCRIPTION OF THE DRAWINGS

FIG. 1 is a top perspective view of the present invention.

FIG. 2 is a bottom perspective view of the present invention.

FIG. 3 is a right-side view of the present invention.

FIG. 4 is a top view of the present invention.

FIG. 5 is a bottom view of the present invention.

FIG. 6 is a front view of the present invention.

FIG. 7 is a rear view of the present invention.

FIG. 8 is a perspective view of a section taken at line 8-8 of FIG. 4.

FIG. 9 is a right-side view of a section taken at line 8-8 of FIG. 4.

### DETAILED DESCRIPTIONS OF THE INVENTION

All illustrations of the drawings are for the purpose of describing selected versions of the present invention and are not intended to limit the scope of the present invention.

The present invention provides a device used for therapeutic massages. The present invention provides a pool raft used within a body of water such as a pool. The present invention provides a device used for therapeutic massage within a body of water. Furthermore, the present invention provides a pool raft that allow the user to lay down and float on the surface a body of water. The present invention comprises a frame, a cup holder, a head rest, and a plurality of magnets, and a plurality of body support frames.

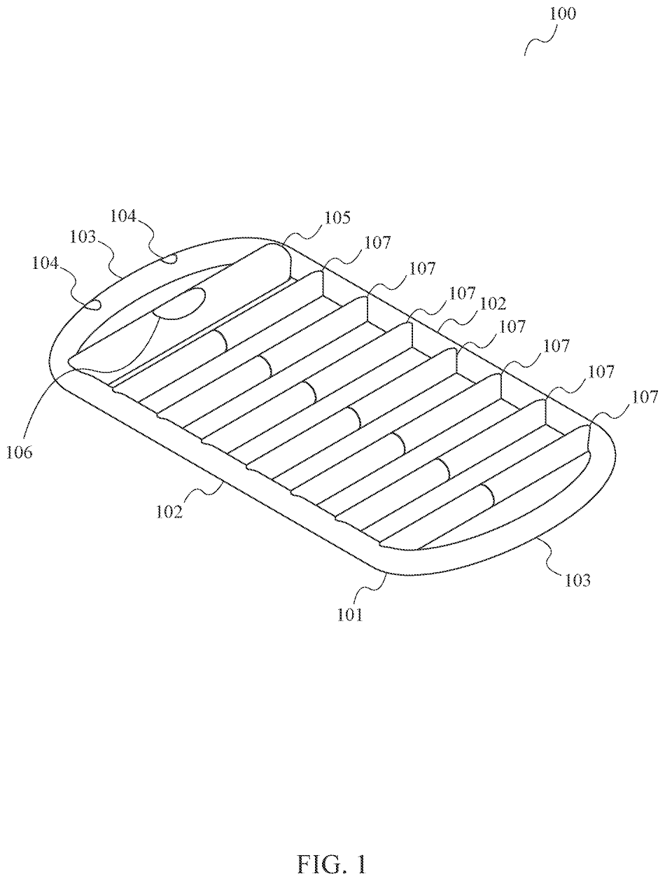

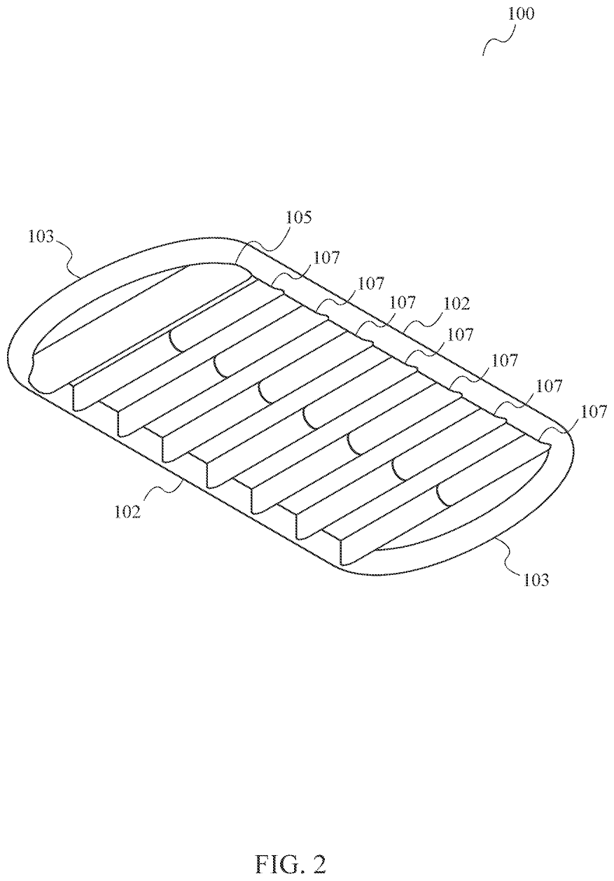

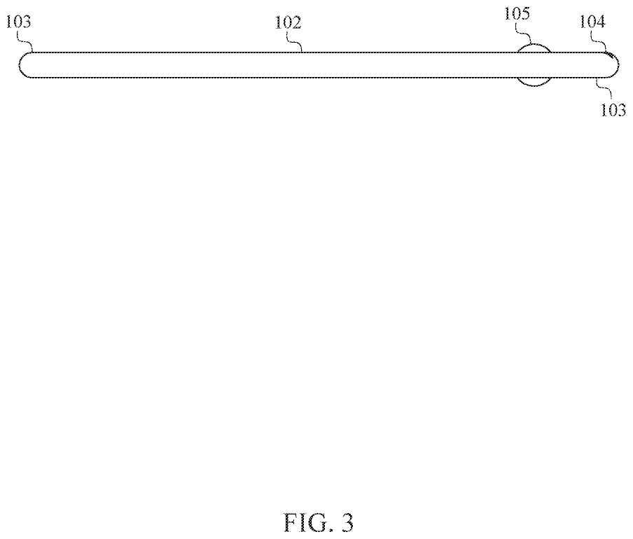

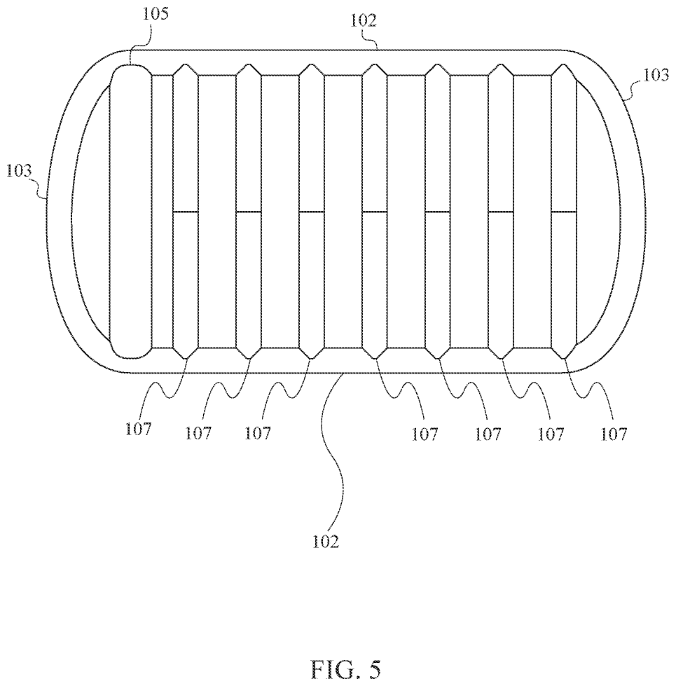

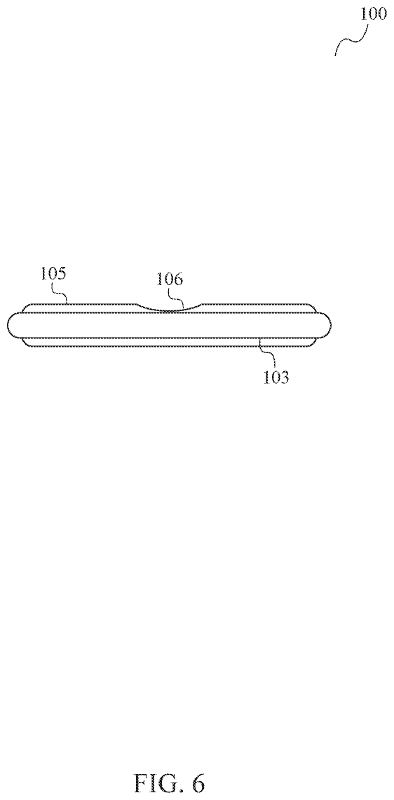

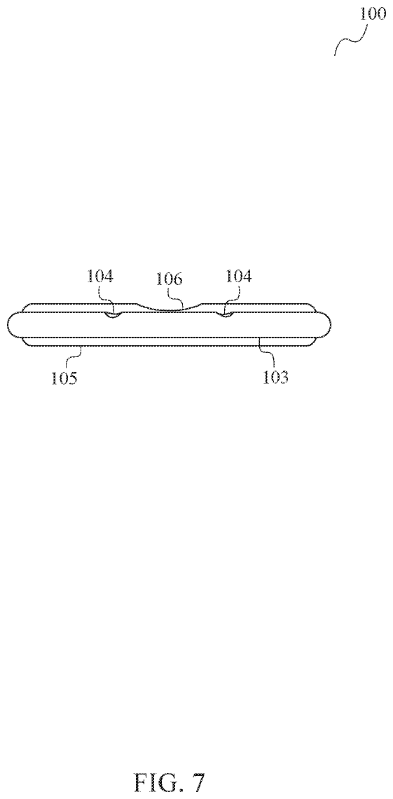

Referring to FIGS. 1-7, the present invention comprises a massage raft 100. The outer frame 101 is the external structure that surrounds the overall components of the present invention. The outer frame 101 is the external support of the present invention. The outer frame 101 is made of polyethylene foam material. The outer frame 101 is structured and made similarly to foam pool swim noodles. Furthermore, the outer frame 101 further comprises two straight frames 102 and two curved frames 103. The two straight frames 102 are aligned and parallel to one another. The two curved frames 103 are aligned and parallel to one another. As can be seen in FIGS. 1, 2, 4, and 5, the two straight frames 102 are connected to the two curved frames 103. More specifically, the ends of the two curved frames 103 are connected to the opposing ends of the two straight frames 102.

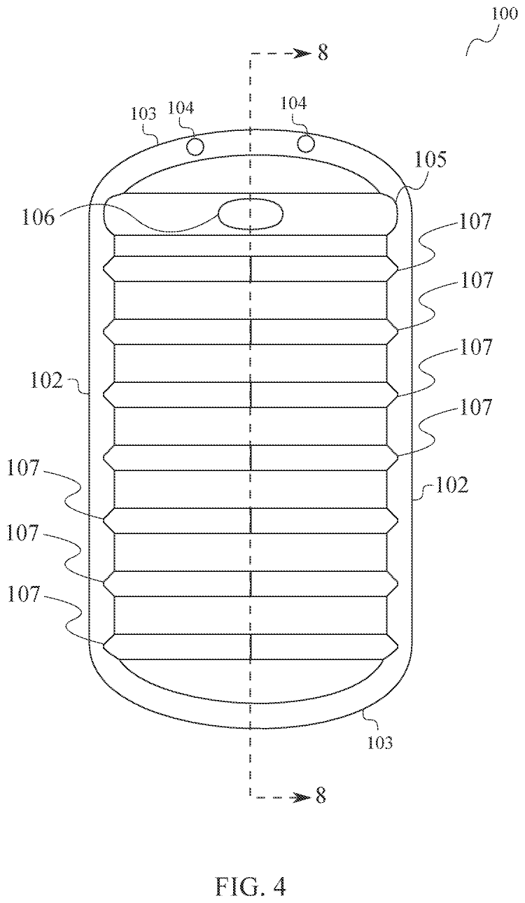

The cup holders 104 are circular crevices designed to hold external objects by the user, ideally a cup/beverage. The cup holders 104 are located on the top end of the outer frame 101. More specifically, the cup holders 104 are positioned on the top surface of the curved frame 103 nearby the connection of the curved frame 103 and the straight frame 102 as can be seen in FIGS. 1 and 4.

The head rest 105 is a tube made of polyethylene foam material designed to allow the user to rest their head. The head rest 105 is connected perpendicularly to the two straight frames 102. More specifically, the head rest 105 is connected perpendicularly and horizontally to the two straight frames 102 towards the connection between the two straight frames 102 and a curved frame 103 as can be seen in FIGS. 1, 2, 4, and 5. The head rest 105 has larger thickness than the outer frame 101. Furthermore, the top surface of the head rest 105 comprises a groove 106 designed to comfortably secure and assist the relaxation of the user's head as can be seen in FIGS. 1 and 4.

The body support frames 107 are frames designed to support the user's body while floating in a body of water. In reference to FIGS. 1, 2, 4, and 5, the body support frames 107 can be seen. The body support frames 107 are positioned horizontally between the straight frames 102, such that the user can lay on the body support frames 107 to rest. The body support frames 107 are horizontally and perpendicularly connected to the two straight frames 102. The body support frames 107 are evenly spaced out from one another. In addition, the body support frames 107 are tubes made of polyethylene foam material. The body support frames 107 are able to detach from the center to allow the user to best fit their needs during a float on a body of water.

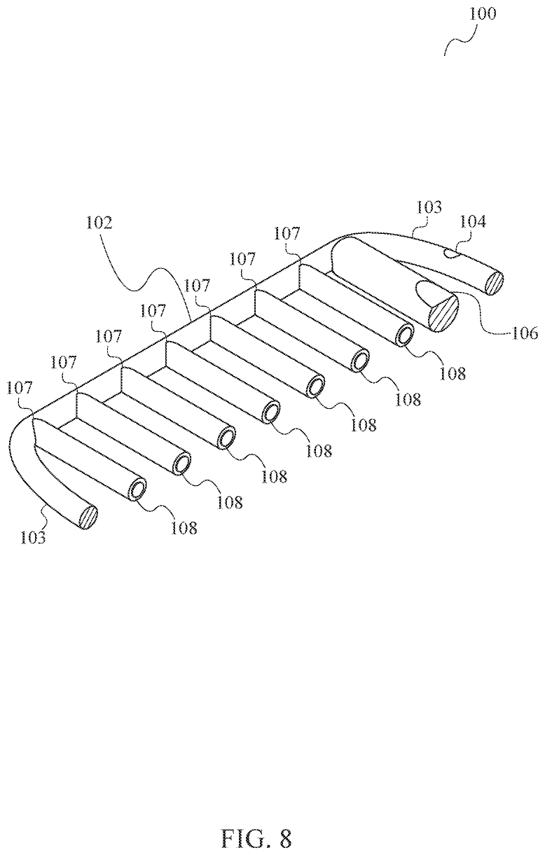

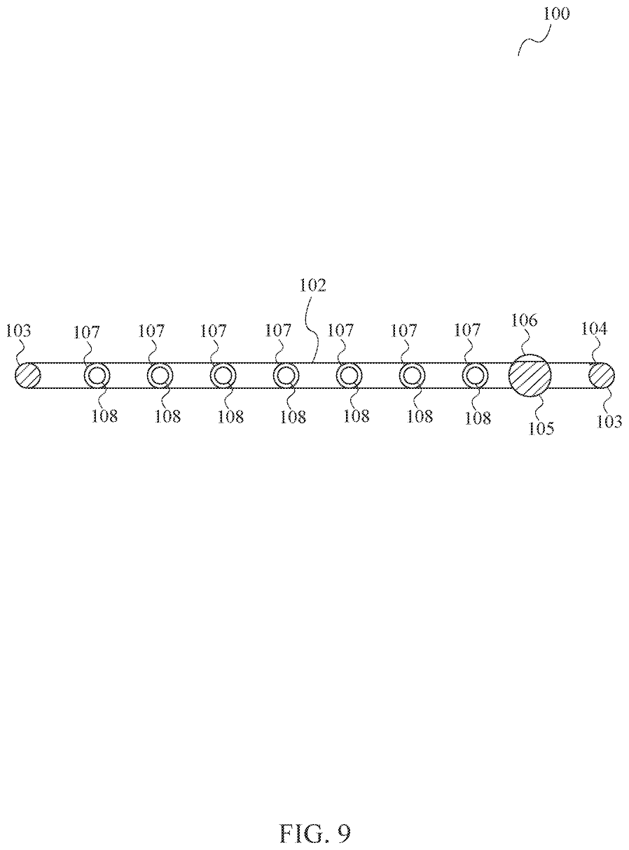

Referring to FIGS. 8-9, the magnets 108 are fastening mechanisms for the present invention. More specifically the magnets 108 are utilized in pairs as fastening mechanisms between the body support frames 107. The magnets 108 are located at each connection between the center of each body support frame.

To use the present invention, the user will find a body of water. The user will place the present invention on the surface of the water. The user will attach/detach the desired amount of body support frames 107 to be used to best fit their comfort. Once the body support frames 107 are set up, the present invention is ready to be used. The user will mount themselves onto the present invention with their heads toward the head rest 105. The user will lay down and float above the surface of the water to allow the waves of water to therapeutically massage their body. In addition, a massage therapist can perform a massage to the user lying on the present invention. The user can also use the cup holders 104 to secure and hold their beverage during the process.

Although the invention has been explained in relation to its preferred embodiment, it is to be understood that many other possible modifications and variations can be made without departing from the spirit and scope of the invention.

What is claimed is:

1. A massage raft comprising:
an outer frame;
a set of body support frames connected to the outer frame; and
a set of magnetic couplers dividing the set of body support frames.

2. The massage raft of claim 1, further comprising a headrest connected to the outer frame.

3. The massage raft of claim 2, wherein the headrest further comprises a groove in a top surface of the headrest.

4. The massage raft of claim 1, wherein the outer frame further comprises a set of straight frames connected by a set of curved frames.

5. The massage raft of claim 4, wherein the set of straight frames are parallel.

6. The massage raft of claim 5, wherein the set body support frames are connected perpendicular to the set of straight frames.

7. The massage raft of claim 1, wherein the set of magnetic couplers are detachably coupled.

8. The massage raft of claim 1, wherein:
the outer frame further comprises polyethylene foam;
the body support frames comprise polyethylene foam.

9. The massage raft of claim 1, further comprising one or more cupholders.

10. A massage raft comprising:
a set of straight frames connected by a set of curved frames;
a set of body support frames connected between the set of straight frames; and
a set of magnetic couplers dividing each body support frame of the set of body support frames.

11. The massage raft of claim 10, further comprising a headrest connected between the set of straight frames.

12. The massage raft of claim 11, wherein the headrest further comprises a groove in a top surface of the headrest.

13. The massage raft of claim 10, wherein the set of magnetic couplers are detachably coupled.

14. The message raft of claim 10, wherein:
the set of straight frames comprise polyethylene foam;
the set of curved frames comprise polyethylene foam; and
the body support frames comprise polyethylene foam.

15. The massage raft of claim 10, further comprises one or more cupholders.

16. A massage raft comprising:
a set of straight frames connected by a set of curved frames
a headrest connected to the set of straight frames
a set of body support frames connected to the set of straight frames
a set of magnetic couplers dividing the set of body support frames.

17. The massage raft of claim 16, wherein the headrest further comprises a groove in a top surface of the headrest.

18. The massage raft of claim 16, wherein the set of magnetic couplers are detachably coupled.

19. The massage raft of claim 16, wherein:
the set of straight frames comprise polyethylene foam;
the set of curved frames comprise polyethylene foam; and
the body support frames comprise polyethylene foam.

20. The massage raft of claim 16, further comprising one or more cupholders.
